(19) United States
(12) Patent Application Publication
(10) Pub. No.: US 2010/0085859 A1
(43) Pub. Date: Apr. 8, 2010

(54) HOLOGRAM RECORDING AND REPRODUCING APPARATUS

(75) Inventors: Kazuo Takahashi, Saitama (JP); Masakazu Ogasawara, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku (JP)

(21) Appl. No.: 12/532,974

(22) PCT Filed: Mar. 29, 2007
(86) PCT No.: PCT/JP2007/056876

§ 371 Date: Dec. 2, 2009

(51) Int. Cl. G11B 7/00

(52) U.S. Cl. 369/103; G9B/7

(57) ABSTRACT

A laser beam emitted from a laser light source is divided into two laser beams, a 2-dimensional spatial modulation is performed to one of the two divided laser beams based on recording information, the modulated laser beam is projected as signal light onto a recording medium, the other laser beam is projected as reference light onto the recording medium, and the recording information is recorded onto the recording medium. The recording information recorded on the recording medium is reproduced based on the laser beam transmitted through or reflected by the recording medium. An optical system includes: a rotatable mirror portion for guiding the reference light to the recording medium at an angle according to the direction of its reflecting surface; a vibration proofing member coupled with a rear surface of the mirror portion; and a driving mechanism which decides an angle position of the mirror portion and is coupled with the mirror portion.

### TECHNICAL FIELD

The present invention relates to a hologram recording and reproducing apparatus.

### BACKGROUND ART

A hologram recording and reproducing apparatus is an apparatus that records a digital signal into a holographic recording medium (photorefractive crystalline such as LiNbO₃) and reproduces it, and can record and reproduce data in units of two-dimensional plane page, and can perform the recording and reproduction in a number of pages. A fundamental construction of the apparatus is shown in FIG. 1.

In FIG. 1, an encoder 2 pages time-sequential recording data to be recorded onto a holographic recording medium 1, that is, rearranges it into data corresponding to a two-dimensional unit plane page serving as a predetermined recording area unit, for example, a data layout of 480 bits (in the vertical direction)×640 bits (in the lateral direction), thereby forming unit page-sequential data. The unit page-sequential data is sent to an SLM (Spatial Light Modulator) 3.

The SLM 3 has a modulation processing unit of 480 pixels (in the vertical direction)×640 pixels (in the lateral direction) corresponding to the unit page, optically modulates the projected signal light in accordance with the unit page-sequential data from the encoder 2, and guides a modulated beam which is thus obtained, toward a lens 4. In more detail, the SLM 3 allows the signal light to pass in response to a logical value “1” of the unit page-sequential data as an electric signal and shuts out the signal light in response to a logical value “0”, so that an electro-optical conversion according to the contents of each bit in the unit page-sequential data is accomplished and modulation signal light as an optical signal of a unit page sequence is produced.

The modulation signal light enters the holographic recording medium 1 through the lens 4. Besides the modulation signal light, reference light is projected onto the holographic recording medium 1 at an angle β from a predetermined reference line which perpendicularly crosses an optical axis of a beam indicative of the optical signal.

When the modulation signal light and the reference light simultaneously enter the holographic recording medium 1, both of the beams interfere in the holographic recording medium 1. An interference pattern is recorded onto the holographic recording medium 1, so that the data is recorded onto the holographic recording medium 1. By changing the incident angle β and allowing the reference light to enter, the data can be recorded onto the holographic recording medium 1 by a three-dimensional predetermined recording area unit (hereinbelow, referred to as a “book”) including a plurality of sheets of two-dimensional data.

To reproduce the recording data from the holographic recording medium 1, unlike the case upon recording, the signal light is not allowed to enter the holographic recording medium 1 but only the reference light is allowed to enter the holographic recording medium 1 at the same incident angle β as that upon recording. Diffraction light from the interference pattern recorded in the holographic recording medium 1 is, thus, guided to a lens 5.

The diffraction light which has reached the lens 5 passes therethrough and enters, as read light, a CCD (Charge-Coupled Device) 6 having a light receiving region of 480 pixels (in the vertical direction)×640 pixels (in the lateral direction). Each pixel in the light receiving region of the CCD 6 corresponds to each pixel on a recording surface of the holographic recording medium 1. The CCD 6 converts brightness/darkness of the incident light into a magnitude of a level of an electric signal every pixel, that is, generates an analog electric signal showing a level according to luminance of the incident light, and supplies it as a read signal to a decoder 7.

The decoder 7 has a function for binarizing or binary-discriminating the read signal. When the level of the read signal is larger than a slice level serving as a threshold value, the decoder 7 recognizes the logical value “1”, and when it is smaller than the slice level, the decoder 7 recognizes the logical value “0”, thereby obtaining a digital signal showing the recognized value. A conversion opposite to the paging process performed in the encoder 2 is also executed to the digital signal, thereby producing time-sequential reproduction data.

As a method of recording a plurality of sheets of 2-dimensional pages onto the recording medium, an angle multiplexing system in which the irradiation angle of the reference light as mentioned above is changed has been known. In the recording and reproducing apparatus using the system, a movable mirror which is rotatably attached is used as means for changing the irradiation angle of the reference light. The movable mirror changes the direction of its reflecting surface every page, thereby guiding a laser beam emitted from a light source to a predetermined position of the recording medium while changing its irradiation angle.

Patent Literature 1: Japanese Patent Kokai No. 2001-118253

Patent Literature 2: Japanese Patent Kokai No. 10-201153

### DISCLOSURE OF INVENTION

### Problem to be solved by the Invention

In a hologram recording and reproducing apparatus, since the recording and reproduction are executed while changing the irradiation angle of the reference light by the movable mirror, it is necessary to drive the movable mirror at a high speed in order to execute the high-speed recording and reproduction. In order to drive the movable mirror at a high speed, it is necessary to increase a torque of a driving unit of the movable mirror and to reduce a weight of the movable mirror itself. If a rotational torque of the driving unit is increased, however, an acceleration which is applied to the movable mirror increases and if the weight of the movable mirror is reduced, rigidity is decreased. When the driving of the movable mirror is started or stopped, therefore, the movable mirror is deformed or a resonance vibration is liable to be caused, so that the irradiation angle of the reference light becomes unstable. As shown in FIG. 2, the resonance vibration denotes that the movable mirror vibrates at a specific resonance frequency while causing a curve (vibrating mode 1) and a torsion (vibrating mode 2). Generally, the lower the rigidity of the movable mirror is, the more the deformation increases and the resonance frequency decreases, so that it takes a long time until the vibration is settled. The deformation and vibration of the movable mirror as mentioned above become a problem for realizing stabilization and higher speed of the recording and reproduction. That is, in the hologram recording and reproducing apparatus, for a period of time during which the movable mirror is vibrating, since the reference light is not stable, the recording and reproduction are started after the vibration has been settled. The vibration that is caused in the movable mirror as mentioned above is a problem which cannot be solved only by improvement of a control method and a fixing method of the movable mirror.

The invention has been made in consideration of the problems mentioned above and it is an object of the invention to provide a hologram recording and reproducing apparatus which can stably execute the recording and reproduction at a high speed by effectively suppressing a vibration that is caused when driving a movable mirror.

### Measure to Solve the Problem

According to the invention, there is provided a hologram recording and reproducing apparatus comprising: a laser light source; dividing means for dividing a laser beam emitted from the laser light source and forming two division laser beams; spatial modulating means for performing a two-dimensional spatial modulation to one of the two division laser beams based on recording information; an optical system for projecting the one spatially modulated division laser beam as signal light onto a recording medium and projecting the other one of the division laser beams as reference light onto the recording medium, thereby recording the recording information onto the recording medium; and reproducing means for reproducing the recording information recorded on the recording medium based on the laser beam transmitted through or reflected by the recording medium, wherein the optical system includes a mirror portion which is rotatably provided and guides the reference light to the recording medium at an angle according to a direction of its reflecting surface, a vibration proofing member coupled with the mirror portion, and a driving mechanism which decides an angle position of the mirror portion and is coupled with the mirror portion.

### BRIEF DESCRIPTION OF DRAWINGS

FIG. 1 is a block diagram showing a fundamental construction of a hologram recording and reproducing apparatus in the related art.

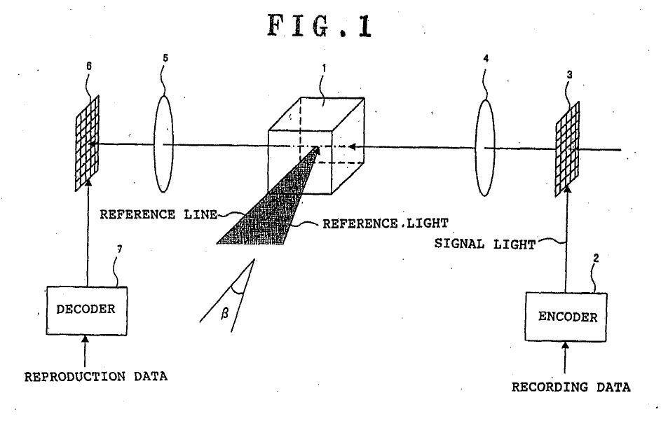

FIG. 2 is a diagram showing vibrating modes of a movable mirror.

FIG. 3 is a block diagram showing a construction of a hologram recording and reproducing apparatus of the invention.

FIG. 4 is a block diagram showing a construction of a pickup as an embodiment of the invention.

FIG. 5 is a perspective view showing a construction of a movable mirror as an embodiment of the invention.

FIG. 6 is a flowchart showing the recording operation in the hologram recording and reproducing apparatus according to the embodiment of the invention.

FIGS. 7A and 7B are timing charts showing the operation of each unit at the time of driving the movable mirror.

FIGS. 8A and 8B are a perspective view showing another structure of a vibration proofing member according to the invention a plan view showing its rib pattern, respectively.

FIGS. 9A to 9C are plan views each showing an example of the rib pattern of the vibration proofing member having a rib structure according to the invention.

FIG. 10 is a perspective view showing another structure of the vibration proofing member according to the invention.

FIGS. 11A and 11B are a diagram of a general vibrating model of a structure and a diagram showing general vibrating characteristics of the structure, respectively.

FIG. 12 is a diagram of a vibrating model of a dynamic damper structure.

FIGS. 13A to 13C are perspective views each showing another structure of the vibration proofing member according to the invention.

### DESCRIPTION OF REFERENCE NUMERALS

1 . . . Recording medium
10 . . . Light source for recording and reproduction
11 . . . Collimator lens
12 . . . Shutter
14 . . . Beam expander
15 . . . Spatial light modulator (SLM)
16 . . . Fourier transforming lens
17 . . . Relay lens
18 . . . Relay lens
20 . . . Image pickup device
30 . . . Movable mirror
31 . . . Plane mirror portion
32 . . . Vibration proofing member
33 . . . Rotary axis
34 . . . Motor
140 . . . Mirror driving circuit
300 . . . Main controller (CPU)

### BEST MODE FOR CARRYING OUT THE INVENTION

An embodiment of the invention will be described hereinbelow with reference to the drawings. In the following diagrams, substantially the same or equivalent component elements and portions are designated by the same reference numerals.

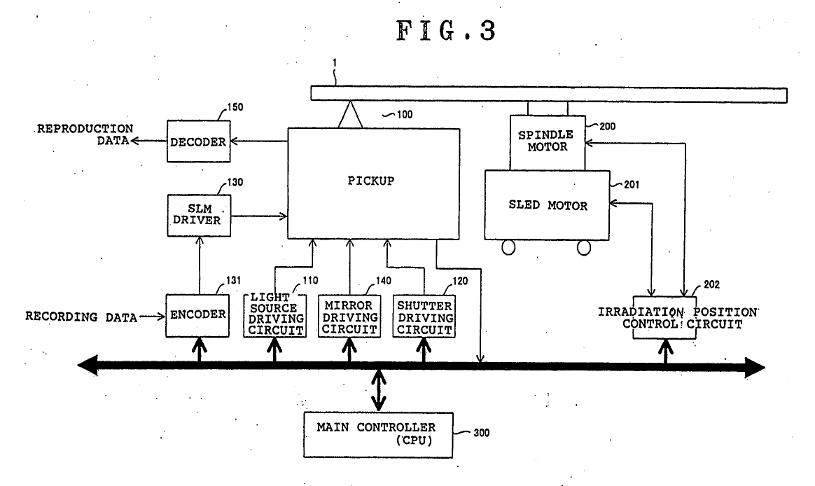

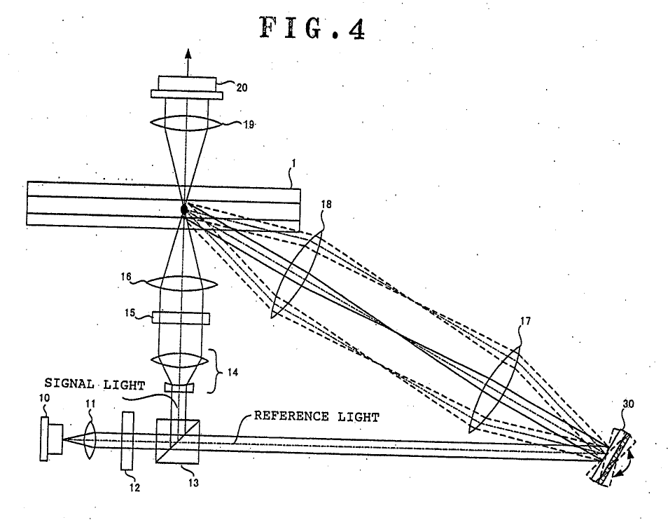

FIG. 3 is a block diagram showing a whole construction of a hologram recording and reproducing apparatus of the invention. FIG. 4 is a block diagram showing a construction of a pickup 100 which is mounted in the hologram recording and reproducing apparatus of the invention. The construction of the hologram recording and reproducing apparatus of the invention will be described hereinbelow with reference to FIGS. 3 and 4.

The holographic recording medium 1 (hereinafter, referred to as a recording medium 1) has a recording layer made of a photosensitive material and is sandwiched by substrates or protecting layers made of a resin or glass. For example, a photosensitive material such as lithium niobate monocrystal of a polymer or photorefractive material is used for the recording layer. A shape of the recording medium 1 is, for example, a disk shape. The recording medium 1 is fixed to a spindle motor 200 by a clamping mechanism and, when the spindle motor 200 is rotated, an irradiation position of a coherent beam on the recording medium can be moved in the tangential direction. The spindle motor 200 is fixed to a sled motor 201. When the sled motor 201 performs a rotational feed, the irradiation position of the coherent beam on the recording medium can be also moved in the radial direction. The shape of the recording medium 1 is not limited to the disk shape but can have a card shape or another shape. In this case, a driving mechanism for moving the irradiation position of the coherent beam makes positioning control according to the shape of the recording medium.

An irradiation position control circuit 202 makes driving control of the spindle motor 200 and the sled motor 201 in accordance with control signals including a timing signal and the like which are supplied from a main controller (hereinbelow, referred to as a CPU) 300 for controlling the whole apparatus. Specifically speaking, address information included in a reproduction signal from the recording medium 1 or a rotational angle detection signal from a rotary encoder (not shown) provided for the spindle motor 200 and a position detection signal from a position sensor (not shown) provided for the sled motor 201 are supplied to the CPU 300. Based on those detection signals, the CPU 300 supplies a control signal to the irradiation position control circuit 202 so that an irradiation position of the coherent beam is positioned to a proper position at proper timing. Based on the control signal, the irradiation position control circuit 202 produces a spindle motor driving signal and a sled motor driving signal, thereby allowing the spindle motor 200 and the sled motor 201 to be individually driven. The irradiation position of the coherent beam is, consequently, controlled in the tangential direction and the radial direction. By positioning the irradiation position of the coherent beam to an arbitrary position on the recording medium, the book recording can be performed onto the whole surface of the recording medium 1.

A light source 10 for recording and reproduction is constructed by, for example, a semiconductor laser and emits a laser beam of, for example, a blue violet color having a wavelength of 405 nm in response to a driving signal which is supplied from a light source driving circuit 110. The light source driving circuit 110 makes driving control of the light source 10 for recording and reproduction in accordance with the control signal including the timing signal and the like which are supplied from the CPU 300. Specifically speaking, a laser power detection signal which is generated from a photodetector (not shown) for monitoring a power of the laser beam emitted from the light source 10 for recording and reproduction is supplied to the CPU 300. Based on the laser power detection signal, the CPU 300 supplies a control signal for allowing the light source driving circuit 110 to emit the laser beam of the proper recording power. The light source driving circuit 110 produces a driving signal based on the control signal and supplies it to the light source 10 for recording and reproduction. The light source 10 for recording and reproduction, consequently, emits the laser beam of the power suitable for recording and reproduction at proper timing.

The laser beam emitted from the light source 10 for recording and reproduction is shaped into a laser beam bundle by a collimator lens 11. A shutter 12 is for example composed of a mechanical shutter, an acousto-optical device, or the like. Based on a driving signal which is supplied from a shutter driving circuit 120, the shutter 12 allows the laser beam bundle transmitted through the collimator lens 11 to pass and shuts it off.

The laser beam which passed through the shutter 12 is divided into signal light and reference light by a beam splitter 13. A beam diameter of the signal light is magnified by a beam expander 14, so that the signal light becomes parallel light and enters an SLM (Spatial Light Modulator) 15 constructed by a panel of a transmitting TFT liquid crystal device (LCD) or the like. The SLM 15 forms a dot pattern of brightness/darkness based on a data signal to be recorded. In more detail, an encoder 131 converts a recording data signal constructed by a one-dimensional digital signal train into a two-dimensional data train, adds an error correction code to the two-dimensional data train, and produces a two-dimensional data signal (hereinbelow, referred to as a unit page-sequential data signal). An SLM driver 130 forms a driving signal based on the unit page-sequential data signal which is supplied from the encoder 131 and drives the SLM 15. The SLM 15 has a modulation processing unit of, for example, 480 pixels (in the vertical direction)×640 pixels (in the lateral direction) and forms a two-dimensional brightness/darkness dot pattern in accordance with the driving signal. After the signal light passed through the SLM 15, it is light-modulated by the brightness/darkness dot pattern. That is, the SLM 15 turns on/off the projected signal light having the wavelength of 405 nm every pixel in accordance with the unit page-sequential data from the encoder 131, thereby forming a modulation signal light beam. In more detail, the SLM 15 turns on the pixel corresponding to the bit in response to the logical value “1” of the unit page-sequential data as an electric signal, thereby allowing the signal light beam to pass. The SLM 15 turns off the pixel corresponding to the bit in response to the logical value “0”, thereby shutting off the signal light beam. An electro-optical conversion according to the contents of each bit in the unit page-sequential data is, thus, accomplished and the modulation signal light beam serving as an optical signal of the unit page sequence is produced. The modulation signal light is Fourier transformed by a Fourier transforming lens 16 and projected to the recording layer in the recording medium 1.

The reference light divided by the beam splitter 13 is guided to a movable mirror 30. A reflecting surface of the movable mirror 30 is rotated in the direction shown by arrows in the diagram by a driving mechanism such as a motor, so that the movable mirror 30 projects the emitted reference light onto the recording medium 1 at a predetermined angle. When performing the angle multiplexing recording, the reflecting surface is changed step by step, thereby sequentially changing an irradiation angle of the reference light at a predetermined position on the recording medium 1. Relay lenses 17 and 18 are arranged between the movable mirror 30 and the recording medium 1. The relay lenses 17 and 18 construct what is called a 4f optical system and two lenses having a same focal distance f are arranged at an interval of 2f. Owing to the construction of the 4f optical system, even if an angle of the reference light is changed by the movable mirror 30, the irradiation position on the recording medium is held at a predetermined position. That is, the signal light and the reference light cross at a predetermined angle in the predetermined position on the recording medium 1. Since the irradiation angle of the reference light changes sequentially at the irradiation position, a multiplexing recording of the unit page-sequential data is executed and the book recording is executed.

Upon reproducing, for example, the signal light is shut off by the SLM 15 and only the reference light is projected onto the recording medium 1 at the same irradiation angle as that upon recording. Reproduction light which reproduces the interference pattern recorded on the recording medium 1, thus, appears and the reproduction light is guided to an inverse Fourier transforming lens 19. The inverse Fourier transforming lens 19 inversely Fourier transforms the reproduction light, thereby reproducing a brightness/darkness dot pattern image. An image pickup device 20 constructed by a CCD (Charge-Coupled Device) or the like converts the reproduced brightness/darkness dot pattern image into an electric digital signal and supplies it to a decoder 150. Based on a predetermined slice level, the decoder 150 discriminates whether or not a level of the digital signal which is supplied from the image pickup device 20 is equal to “0” or “1”. The decoder 150 executes a transformation opposite to the paging process performed in the encoder 131, thereby producing time-sequential reproduction data.

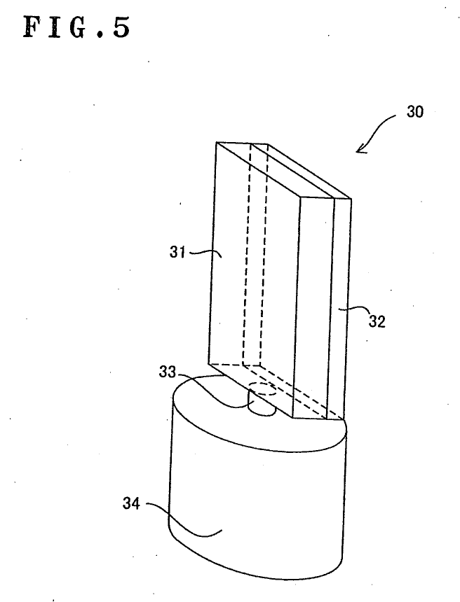

FIG. 5 is a perspective view showing a construction of the movable mirror 30. The movable mirror 30 has a fundamental construction similar to that of what is called a galvano-mirror and is constructed by: a plane mirror portion 31 constructing a reflecting surface; a vibration proofing member 32 provided on the rear surface side of the reflecting surface of the plane mirror portion 31; and a motor 34 coupled with the plane mirror portion 31 through a rotary axis 33. A visco-elastic body is used for the vibration proofing member 32 and is formed by, for example, coating or filling the rear surface of the plane mirror with a silicon-base gel substance. A deformation and a resonance of the plane mirror, particularly, at the time of the start or stop of the driving of the movable mirror 30 can be, consequently, prevented. The vibration proofing member is not limited to the silicon gel but, for example, a member obtained by adhering vibration proofing rubber (butyl rubber, silicone rubber, polyurethane rubber, natural rubber), a high-molecular compound resin of an elastomer system, or the like onto the rear surface of the plane mirror may be used.

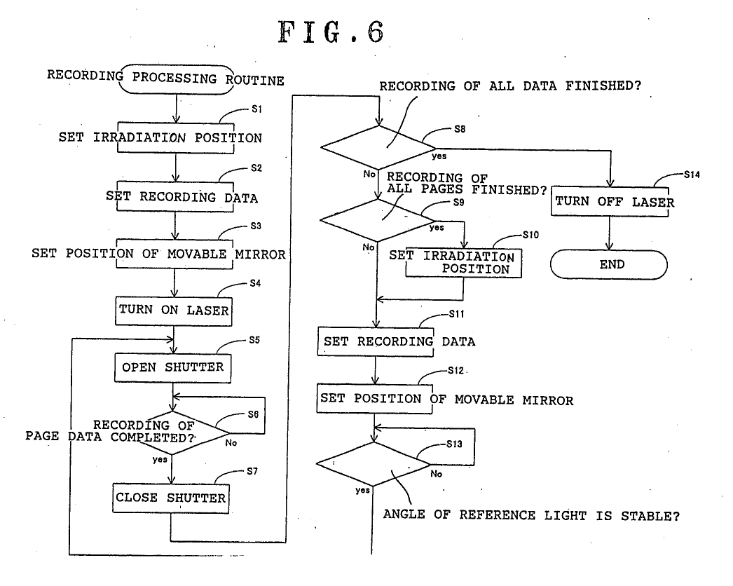

Subsequently, the operation of the hologram recording and reproducing apparatus according to the invention will be described with reference to a flowchart of FIG. 6. The recording operation is executed under control of the CPU 300.

First, the CPU 300 supplies a control signal to the irradiation position control circuit 202 and drives the spindle motor 200 or the sled motor 201, thereby positioning the recording medium so that the coherent light beam is projected to a predetermined position on the recording medium 1 (step S1).

Subsequently, the CPU 300 supplies a control signal to the encoder 131 so as to start the production of the unit page-sequential data corresponding to the data to be recorded. When the unit page-sequential data is produced by the encoder 131, the SLM driver 130 drives the SLM 15 in accordance with the unit page-sequential data. The SLM 15, thus, forms a brightness/darkness dot pattern corresponding to the first page to be recorded (step S2).

Subsequently, the CPU 300 supplies a control signal to a mirror driving circuit 140 so as to allow the irradiation angle of the reference light to correspond to the recording of the first page. The mirror driving circuit 140 supplies a driving signal to the motor 34 in response to the control signal, thereby allowing the direction of the reflecting surface of the movable mirror 30 to correspond to the recording of the first page (step S3).

Subsequently, the CPU 300 supplies a control signal to the light source driving circuit 110 so as to turn on the light source 10 for recording and reproduction (step S4). After that, the CPU 300 supplies a control signal to the shutter driving circuit 120, thereby driving the shutter 12 so as to be set into the passing state (step S5). The signal light and the reference light are, thus, projected onto the recording medium 1 and the first page is recorded onto the recording medium 1.

Subsequently, the CPU 300 discriminates whether or not the page recording has been completed (step S6). If it is determined that the page recording has been completed, the CPU 300 supplies a control signal to the shutter driving circuit 120, thereby driving the shutter 12 so as to be set into the shut-off state (step S7).

Subsequently, the CPU 300 discriminates whether or not the recording of all data to be recorded onto the recording medium 1 has been finished (step S8). If it is determined that the recording of all of the data has been completed, the CPU 300 supplies a control signal to the light source driving circuit 110 so as to stop the projection of the laser beam, thereby turning off the laser beam (step S14). The present recording processing routine is terminated.

If it is determined in step S8 that the recording of all of the data is not completed, the CPU 300 discriminates whether or not the recording of all pages belonging to the relevant book has been completed (step S9). If it is determined in step S9 that the recording of all pages belonging to the book has been completed, the recording process is continued so as to start the recording of a new book. In this case, the CPU 300 positions the recording medium 1 so as to change the irradiation positions of the signal light and the reference light on the recording medium 1 (step S10). That is, the CPU 300 supplies a control signal to the irradiation position control circuit 202, thereby driving the spindle motor 200 or the sled motor 201 and positioning the recording medium 1 so that the coherent beam is projected to the position for recording the new book.

If it is determined in step S9 that the recording of all pages belonging to the book is not completed, the irradiation position of the coherent beam is not changed. In other words, in the case, the recording process is continued so as to record new unit page-sequential data at the present recording position. In the case, the CPU 300 supplies a control signal to the encoder 131 so as to start the production of the new unit page-sequential data corresponding to the data to be recorded. In response to it, the SLM 15 forms a brightness/darkness dot pattern corresponding to the new unit page-sequential data (step S11). Subsequently, the CPU 300 supplies a control signal to the mirror driving circuit 140, thereby making the positioning control of the movable mirror 30 so as to allow the irradiation angle of the reference light to correspond to the recording of the new unit page-sequential data (step S12). Also when a book recording is newly performed, after completion of the positioning process of the recording medium 1 (step S10), the processes of steps S11 and S12 are executed.

Subsequently, the CPU 300 discriminates whether or not the vibration of the movable mirror caused by the positioning of the movable mirror 30 has been settled and the irradiation angle of the reference light has been stabilized (step S13). That is, when the new page recording is started just after the movable mirror was positioned, there is a risk that the irradiation angle of the reference light is not stabilized due to the vibration of the movable mirror 30 and the data is not normally recorded. The discrimination, therefore, about whether or not the irradiation angle of the reference light has been stabilized is made in the step. Specifically speaking, in the step, a time that is required until the vibration of the movable mirror 30 is settled is preset and whether or not the preset time has elapsed is discriminated. After the vibration of the movable mirror 30 was settled and the irradiation angle of the reference light was stabilized, the processing routine is returned to step S5. The shutter 12 is driven so as to be set into the passing state, the reference light and the signal light which have been set to the new irradiation angles are projected onto the recording medium 1, and the recording of the new page or book is started. The processes of steps S5 to S13 are repetitively executed until the recording of all of the data to be recorded onto the recording medium 1 is completed, so that the multiplexing recording of the data is performed. In the foregoing embodiment, although the movement of the recording position on the recording medium has been performed by moving the recording medium 1 in the radial direction and the tangential direction, it may be performed by moving the pickup 100 toward the recording medium 1.

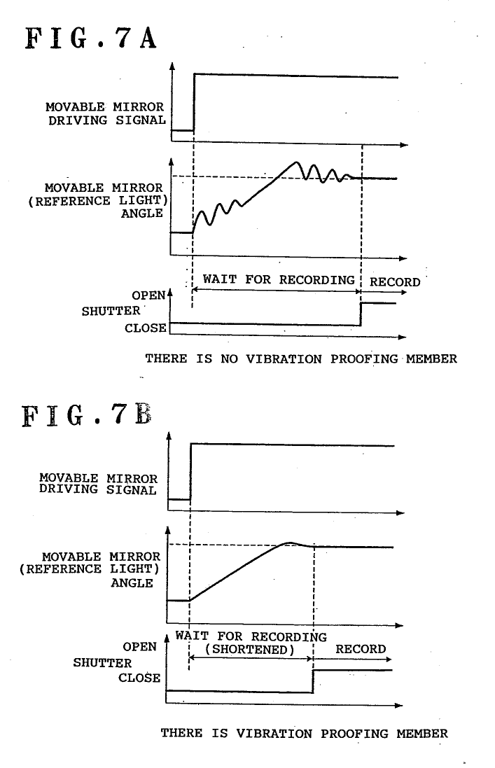

FIGS. 7A and 7B are timing charts showing the operation of each unit which is executed until the processing routine is returned to step S5 and the shutter 12 enters the passing state after the movable mirror 30 was positioned in step S12 in the recording processing routine with respect to each of the case where the vibration proofing member 32 is not attached to the movable mirror (FIG. 7A) and the case where the vibration proofing member 32 has been attached (FIG. 7B). The mirror driving signal, the angle of the movable mirror (angle of the reference light), and the operating timing for the shutter opening/closing states are shown in FIGS. 7A and 7B, respectively. When the driving signal is supplied to the movable mirror 30 in order to set the angle of the reference light, the movable mirror 30 starts to rotate. In this instance, particularly, a large torque is generated at the start and end of the rotation of the movable mirror. In the case where the vibration proofing member 32 is not attached to the movable mirror 30 (FIG. 7A), the mirror vibrates and a certain predetermined time is required until the vibration is converged. Since the angle of the reference light becomes unstable for a period of time during which the mirror vibration is converged, the recording and reproduction cannot be executed. The shutter 12 is in the shut-off state for the period of time. That is, the period of time until the angle of the reference light is stabilized after the start of the supply of the movable mirror driving signal becomes a recording waiting time. When the vibration proofing member 32 has been attached to the movable mirror 30 (FIG. 7B), the vibration proofing member 32 functions as a damping element, the vibration that is caused upon driving of the mirror is promptly converged, and the recording waiting time is shortened. That is, by providing the vibration proofing member 32 for the movable mirror, the high-speed recording can be performed. The vibration proofing effect is also derived upon reproduction.

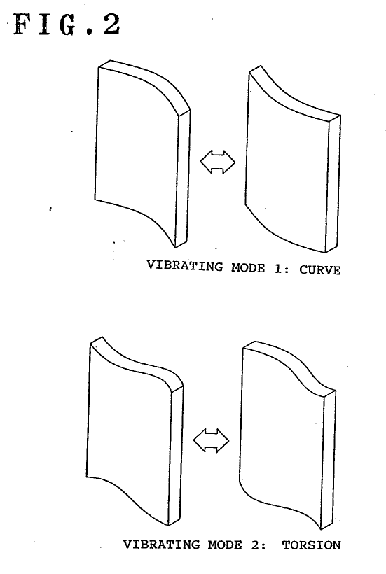

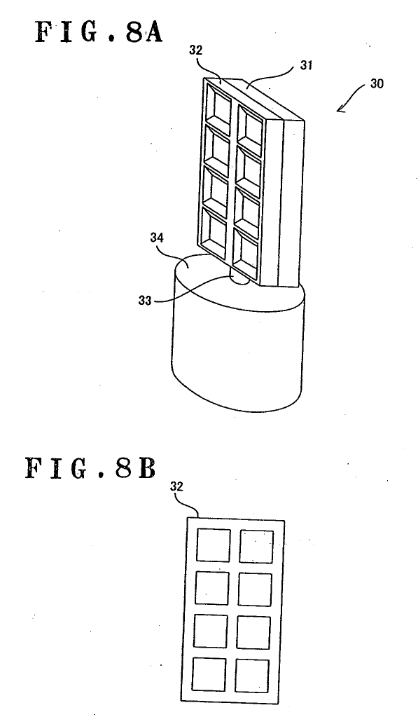

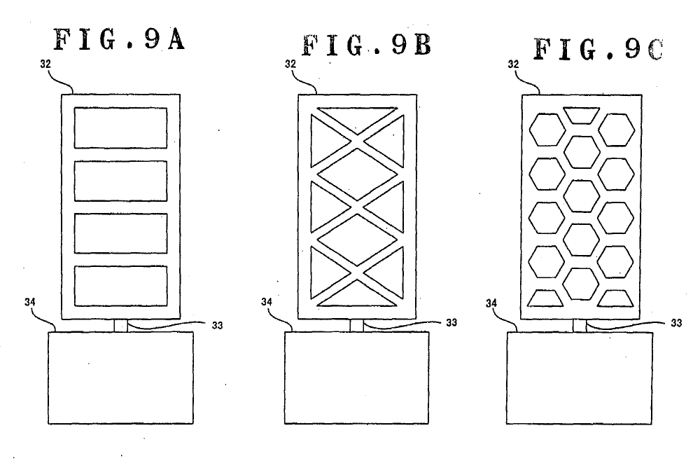

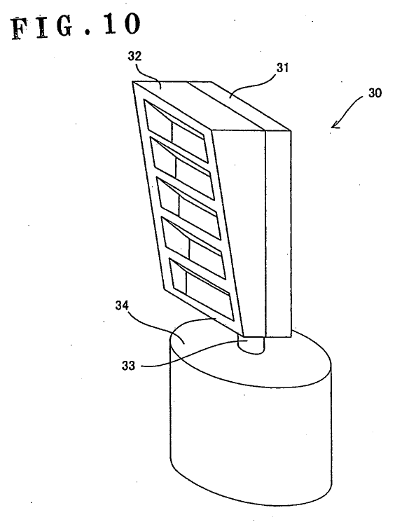

The structure serving as a passive vibrating system such as a plane mirror portion of the movable mirror generally has a plurality of natural frequencies and vibrating modes which are decided based on the rigidity, viscosity, elasticity, and the like of the structure. Some of them become causes of an adverse influence on the system such as oscillation and self-excited vibration. It is, therefore, necessary to assure the stability of the system by changing the natural frequency by changing the structure or by reducing the vibration. Although there is a method of raising the rigidity of the structure as a simple measure, in the case, there is a problem of an increase in weight in association with the increase in rigidity of the structure. In order to raise the rigidity of the plane mirror portion of the movable mirror while avoiding the increase in weight, therefore, it is preferable that the vibration proofing member 32 provided on the rear surface side of the reflecting surface of the plane mirror portion 31 has a rib structure as illustrated in FIGS. 8A and 8B. For the vibrating mode of the curve as illustrated in FIG. 2, it is preferable to provide ribs which are perpendicular to the rotary axis 33 as illustrated in FIG. 9A. For the vibrating mode of the torsion as illustrated in FIG. 2, it is preferable to provide ribs in the direction which are inclined to the rotary axis 33 as illustrated in FIG. 9B. Although it is necessary that the structure of the ribs has a proper shape for the vibrating mode, when the vibrating mode is complicated, it is also possible to cope with the case by a honeycomb structure as illustrated in FIG. 9C. The plane mirror portion 31 has such characteristics that the more the distances from the motor 34 and the rotary axis 33 are away, the more the vibration is liable to occur. To cope with those characteristics, for example, as illustrated in FIG. 10, it is preferable that by thickening the vibration proofing member 32 as the distances from the motor 34 and the rotary axis 33 are away, the rigidity of the vibration proofing member is raised in a portion where the vibration is liable to occur. In the case, the thickness of the vibration proofing member is set to be constant and a material forming the vibration proofing member may be changed in accordance with the distances from the motor and the rotary axis. That is, the portion where the vibration is liable to occur may be formed by a material whose rigidity is higher than those of other portions. By allowing the vibration proofing member to have the structure as mentioned above, the light weight can be realized while maintaining the rigidity of the movable mirror and both of the high-speed driving and the vibration proofing of the movable mirror can be accomplished.

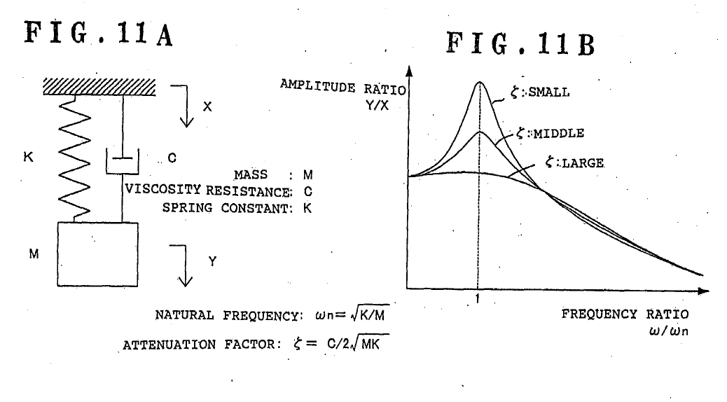

Besides the method of raising the rigidity of the plane mirror portion, the structure can be also changed so as to reduce the vibration. For example, as a vibrating system of the general structure, there is a vibrating model as illustrated in FIG. 11A. In the diagram, m denotes a mass of the structure, c indicates a viscosity resistance, and k shows a spring constant. In the vibrating model, a natural frequency ωn of the structure is ωn=(k/m)^{1/2} and an attenuation factor ζ is ζ=C/2(mk)^{1/2}. Vibrating characteristics of the structure in the vibrating model are shown in FIG. 11B. As shown in the diagram, it has been known that by raising the attenuation factor ζ of the structure, the vibration at the natural frequency decreases. In order to add the damping element to the plane mirror portion of the movable mirror, it can be realized by adhering a material having high viscoelasticity such as rubber or silicon gel onto the rear surface of the plane mirror portion. Further, if the rigidity and the viscoelasticity are changed by filling a material having the high viscoelasticity into concave portions of the rib structure, since the natural frequency of the plane mirror portion can be also changed, a larger damping effect can be expected.

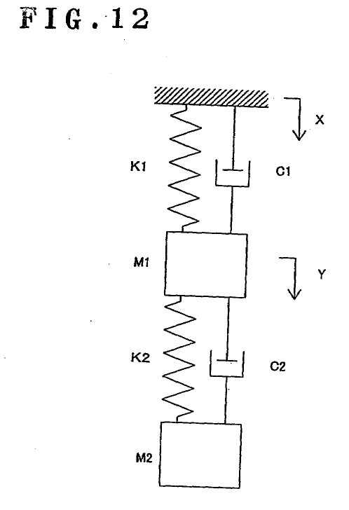

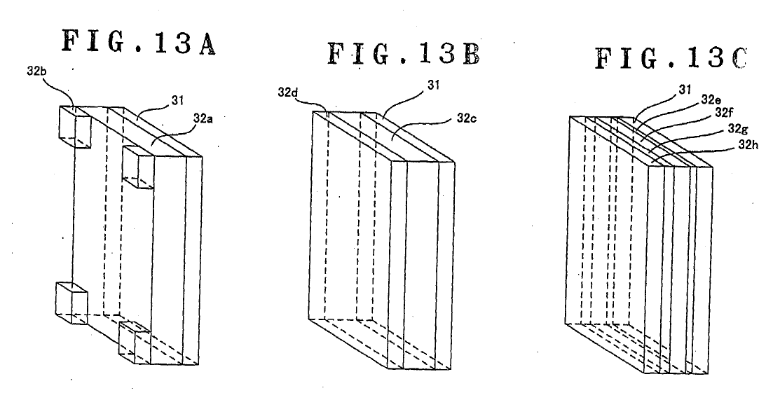

FIG. 12 shows a structure of what is called a dynamic damper in which a new vibrating system is added to a vibrating system to be vibration-proofed. The vibrating system which is added is constructed so that a natural frequency coincides with that of the original vibrating system and a phase is opposite to that of the original vibrating system. In the addition of the new vibrating system to the movable mirror, for example, as illustrated in FIG. 13A, a vibration proofing portion 32a made of the material having high viscoelasticity such as rubber or silicon gel is provided on the rear surface side of the reflecting surface of the plane mirror portion 31 made of glass or the like and, further, a vibration proofing portion 32b made of a material having high rigidity such as metal or glass is attached as a counter weight to the vibration proofing portion 32a.

As illustrated in FIG. 13B, a vibration proofing portion 32c made of the material having high viscoelasticity such as rubber or silicon gel may be provided on the rear surface side of the reflecting surface of the plane mirror portion 31 made of glass or the like and, further, a vibration proofing portion 32d made of the same material as that of the plane mirror portion 31 may be attached to the vibration proofing portion 32c. As illustrated in FIG. 13C, a vibration proofing member having a laminate structure in which vibration proofing portions (32e, 32g) made of the material having high viscoelasticity such as rubber or silicon gel and vibration proofing portions (32f, 32h) made of the same material as that of the plane mirror portion 31 have alternately been laminated may be provided on the rear surface side of the reflecting surface of the plane mirror portion 31.

As will be apparent from the above description, according to the hologram recording and reproducing apparatus of the invention, the settling time that is required when changing the irradiation angle of the reference light to the recording medium is shortened, since it is constructed in such a manner that the vibration proofing member is provided on the rear surface side of the reflecting surface of the movable mirror and the deformation and vibration of the mirror itself are suppressed. Since the weight of the movable mirror is reduced and even if the movable mirror is driven at a high speed, the vibration accompanied with the curve and deformation becomes difficult to occur, it is possible to contribute to the realization of a high speed of the recording and reproduction.

Although the construction is simpler and more reasonable as compared with preventing the vibration by the driving mechanism and the control method of the movable mirror, the vibration can be effectively suppressed without causing an operation delay and a decrease in response speed. Further, although a case where a resonance of the mirror is caused by a shock or a vibration from the outside is considered, according to the invention, since the vibration proofing member is provided for the mirror itself, the vibration of the mirror can be suppressed not only for the vibration that is caused by the driving mechanism but also for the shock or vibration from the outside.

1. A hologram recording apparatus comprising:
a laser light source;
dividing device for dividing a laser beam emitted from said laser light source and forming two division laser beams;
spatial modulating device for performing a two-dimensional spatial modulation to one of said two division laser beams based on recording information; and
an optical system for projecting said one spatially modulated division laser beam as signal light onto a recording medium and projecting the other one of said division laser beams as reference light onto said recording medium, thereby recording said recording information onto said recording medium,
wherein said optical system includes a mirror portion which is rotatably provided and guides said reference light to said recording medium at an angle according to a direction of its reflecting surface, a vibration proofing member coupled with said mirror portion, and a driving mechanism which decides an angle position of said mirror portion and is coupled with said mirror portion, said vibration proofing member has viscoelasticity, and said vibration proofing member is provided on a rear surface side of said reflecting surface of said mirror portion.

2. (canceled)

3. A hologram recording apparatus according to claim 1, wherein said vibration proofing member has a rib structure.

4. A hologram recording apparatus according to claim 3, wherein a concave portion of said rib structure is filled with a visco-elastic body.

5. A hologram recording apparatus according to claim 1, wherein said vibration proofing member has mechanical characteristics different from those of said mirror portion.

6. (canceled)

7. A hologram recording apparatus according to claim 1, wherein said vibration proofing member is made of a plurality of materials having different mechanical characteristics.

8. A hologram recording apparatus according to claim 7, wherein said vibration proofing member has a layer made of a visco-elastic body and a layer made of the same material as that of said plane mirror portion.

9. A hologram recording apparatus according to claim 8, wherein said vibration proofing member has a laminate structure in which a layer formed by a plurality of visco-elastic bodies and a layer made of the same material as that of a plurality of said plane mirror portions have alternately been laminated.

10. A hologram recording apparatus according to claim 5, wherein said mechanical characteristics indicate a modulus of elasticity.

11. A hologram recording apparatus according to claim 5, wherein said mechanical characteristics indicate a coefficient of viscosity.

12. A hologram recording apparatus according to claim 5, wherein said mechanical characteristics indicate a modulus of rigidity.

13. A hologram recording apparatus according claim 1, wherein a rigidity of said vibration proofing member changes in such a direction that said mirror portion is away from said driving mechanism.

14. A hologram recording apparatus according to claim 13, wherein a thickness of said vibration proofing member increases in such a direction that said mirror portion is away from said driving mechanism.

15. A hologram recording apparatus according to claim 1, wherein said vibration proofing member has attenuating characteristics at a natural frequency of said mirror portion.

16. A hologram recording and reproducing apparatus comprising:
a laser light source;
dividing device for dividing a laser beam emitted from said laser light source and forming two division laser beams;
spatial modulating device for performing a two-dimensional spatial modulation to one of said two division laser beams based on recording information;
an optical system for projecting said one spatially modulated division laser beam as signal light onto a recording medium and projecting the other one of said division laser beams as reference light onto said recording medium, thereby recording said recording information onto said recording medium; and
reproducing device for reproducing the recording information recorded on said recording medium based on the laser beam transmitted through or reflected by said recording medium,
wherein said optical system includes a mirror portion which is rotatably provided and guides said reference light to said recording medium at an angle according to a direction of its reflecting surface, a vibration proofing member coupled with said minor portion, and a driving mechanism which decides an angle position of said mirror portion and is coupled with said minor portion, said vibration proofing member has viscoelasticity, and said vibration proofing member is provided on a rear surface side of said reflecting surface of said mirror portion.
